(19) United States
(12) Patent Application Publication
(10) Pub. No.: US 2010/0258196 A1
(43) Pub. Date: Oct. 14, 2010

(54) ARRANGEMENT OF MULTIPLE PUMPS FOR DELIVERY OF PROCESS MATERIALS

(75) Inventors: Chris MELCER, Aptos, CA (US); Jamie A. GRAVES, Portland, OR (US); Bryan FLETCHER, Portland, OR (US); Koh I. MURAI, Yamhill, OR (US); David D. KANDIYELI, Mesa, AZ (US)

Correspondence Address: MICHAEL O. SCHEINBERG, P.O. BOX 164140, AUSTIN, TX, 78716-4140, US

(73) Assignee: MEGA FLUID SYSTEMS, INC., TUALATIN, OR (US)

(21) Appl. No.: 12/760,541

(22) Filed: Apr. 14, 2010

Related U.S. Application Data
(60) Provisional application No. 61/212,650, filed on Apr. 14, 2009.

(51) Int. Cl. F17D 1/00; F04B 25/00; G01M 19/00

(52) U.S. Cl. 137/2; 417/253; 73/865.8

(57) ABSTRACT

A method and apparatus for delivering process materials in a bulk delivery system includes a plurality of pumps arranged in series along a material supply line, wherein the capacity of each pump is such that less than all of the pumps operating simultaneously can provide a desired level of system performance for a given application. In at least one preferred embodiment, a plurality of pumps include three pumps are arranged in series. Preferred embodiments provide several benefits over a parallel arrangement of two larger pumps including, in the case of a single pump failure, that the remaining pumps are signaled to increase speed to restore system performance to restore supply line pressure with less perturbation than that realized in a two-pump, parallel arranged system. Methods are also provided herein for determining which of the three pumps is a failed pump in such a case.

### This application claims priority from U.S. Provisional Patent Application No. 61/212,650 filed on Apr. 14, 2009, which is incorporated herein by reference in its entirety.

### TECHNICAL FIELD OF THE INVENTION

The present invention is directed to a method and apparatus for arranging multiple pumps for the delivery of process materials.

### BACKGROUND OF THE INVENTION

Bulk delivery systems are used, for example, to supply process equipment in the pharmaceutical, cosmetic and semiconductor industries with process materials such as liquid chemicals or slurries. Typically, a single distribution pump is used to supply the process materials. If the pump fails to provide sufficient volume or pressure, for example when the pump malfunctions, the delivery of the process materials may be interrupted or otherwise significantly compromised. To ensure the recovery from such an occurrence, bulk delivery systems typically include an extra pump (i.e., a second or redundant pump of equal capacity to the first pump).

FIG. 1 shows a typical prior art arrangement of a bulk delivery system 100 having a primary pump and a second redundant pump arranged in parallel with the primary pump. Here, a first primary pump 10 is located on the main supply line 12, while a second redundant pump 14 is located on a diverted supply line 16. The maximum pressure and flow output of a typical pump used in such an arrangement is typically about 54 psig @ 55 lpm. In operation, the first pump 10 provides for the entire delivery of the process materials from tank 15 while the second pump 14 remains inactive. Process materials are supplied through the main supply line 12 while main valve 18 is open and diverted valve 19 is closed. Typically, pressure sensors monitor loop return pressure at 11 and loop supply pressure at 13. As will be appreciated by one of ordinary skill in the art, pressure and velocity at the point of use are typically required to be above certain predetermined values in order to achieve the desired performance of the particular system for which the bulk delivery system is being used. A prior art bulk material delivery system is described, for example, in U.S. Pat. No. 7,344,298 to Wilmer et al. for “Method and Apparatus for Blending Process Materials” (Mar. 18, 2008) which is incorporated herein by reference.

FIG. 2 is a graph of pressure versus time showing normal operational loop supply pressure and loop return pressure measured at points 20 and 22, respectively. The combination of supply and return pressure are sometimes referred to as a global loop. The graph of FIG. 2 serves to illustrate the possible results of a primary pump failure in the system of FIG. 1. When the first pump 10 fails, at approximately the 16.5-second mark in FIG. 2, there is a resulting drop in both supply and return pressure, as shown on the graphs at points 24 and 26, respectively. To switch to the back-up second pump 14, main valve 18 is closed while diverted valve 19 is opened so that process materials are diverted from the main supply line 12 to the diverted line 16. In the graph of FIG. 2, the back-up pump begins pumping process materials through the diverted fluid line 16 at approximately 18 seconds. Supply pressure and return pressure are restored, as shown in FIG. 2 at points 27 and 28, but not before a serious spike in supply pressure occurs, as shown on the graph at point 29.

Although the redundancy of a second pump in a bulk delivery system allows for continued processing in the event of a pump failure, there are significant drawbacks to a parallel pump arrangement. First, a parallel arrangement of equally sized pumps is expensive. Because only one pump is propelling the process materials along the supply line at any one time, that pump in use must be large enough to carry the full load required by the system, and large pumps are expensive. Also, because the second pump must assume the full load when the first pump fails, at least two large pumps are required in this arrangement and, therefore, the cost associated with pumps doubles. Second, the supply line not in use forms a “dead leg” which can adversely impact chemicals. For example, slurry particles may tend to agglomerate when little or no flow is present in a supply line that is not in use, such as with the dead leg. When flow is eventually applied through that supply line, the agglomerates will resist evenly mixing with the provided flow of process materials, and unevenly blended process materials are typically undesirable.

Finally, as illustrated by FIG. 2, switching service from one pump to the other introduces potentially severe pressure and flow disturbances in the system. When a pump fails or is removed from service, the system must reroute chemicals to the second, or “redundant,” pump, and that routine invariably results in pressure and flow perturbations which may adversely affect processes at the point of use. Because many conventional processes require precise blending of process materials, and precise delivery of those blends, even minor process variations may lead to significant differences in the batch of blended process materials, potentially rendering it useless for its intended application. For example, in some cases it will be desirable to maintain a certain velocity in the global loop lines to help keep the solids in a slurry in suspension. At the very least, a detected spike 29 or other perturbation in flow and pressure caused by such a switching of pumps will typically cause a system alarm to activate, possibly requiring an inconvenient and untimely manual inspection of the entire system.

What is needed is an improved apparatus and method for providing a redundant pumping system to allow continued operation in the event of a pump failure while eliminating or minimizing the disadvantages of prior art systems.

### SUMMARY OF THE INVENTION

Embodiments of the present invention provide for solving the aforementioned problems by arranging multiple pumps in series rather than in parallel. One preferred embodiment includes three relatively smaller pumps arranged in series that operate simultaneously rather than individually as in the prior art. A first advantage of some embodiments of the present invention of the series arrangement over a parallel arrangement is a reduction in cost. Another advantage of some embodiments of the present invention is the elimination of a “dead leg,” or diverted supply line not in continuous use, since pumps configured in series lie along a single supply line. A further advantage of some embodiments of the present invention is the elimination or reduction of system disturbances, or perturbation, in the event of a pump failure.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more through understanding of the present invention, and advantages thereof, reference is now made to the following descriptions taken in conjunction with the accompanying drawings, in which:

FIG. 1 shows a parallel arrangement of larger pumps in a portion of a prior art bulk delivery system;

FIG. 2 is a graph showing supply and return pressures as they are affected by a failed pump scenario of a parallel pump arrangement such as that shown in FIG. 1;

FIG. 3 shows a series arrangement of multiple smaller pumps in accordance with the preferred embodiments of the present invention;

FIG. 4 is a graph showing supply and return pressures as they are affected by a failed pump scenario of a series pump arrangement such as that shown in FIG. 3; and

FIGS. 5-7 are graphs showing the relationship between the performance of three simultaneously operating pumps with the performance of two of the same simultaneously operating pumps but at a different speed.

FIG. 8A shows a bulk delivery system with two sub-systems, each having a separate tank and pumping system.

FIG. 8B shows two sets of three pumps for each of the sub-systems of FIG. 8A.

The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION OF PREFERRED EMBODIMENTS

The present invention is directed to diminishing the disadvantages associated with a parallel arrangement of pumps. To this end, the present invention includes embodiments having an arrangement of multiple pumps for supplying process materials such that failure of any one of the multiple pumps is compensated for by the remaining pumps. Preferred embodiments are useful, for example, in semiconductor manufacturing, such as in a wafer fabrication system. Other uses and applications are described in U.S. Pat. No. 7,344,298 and in U.S. Pat. No. 6,923,568 to Wilmer et al. for “Method and Apparatus for Blending Process Materials” (Aug. 2, 2008), both of which are incorporated herein by reference.

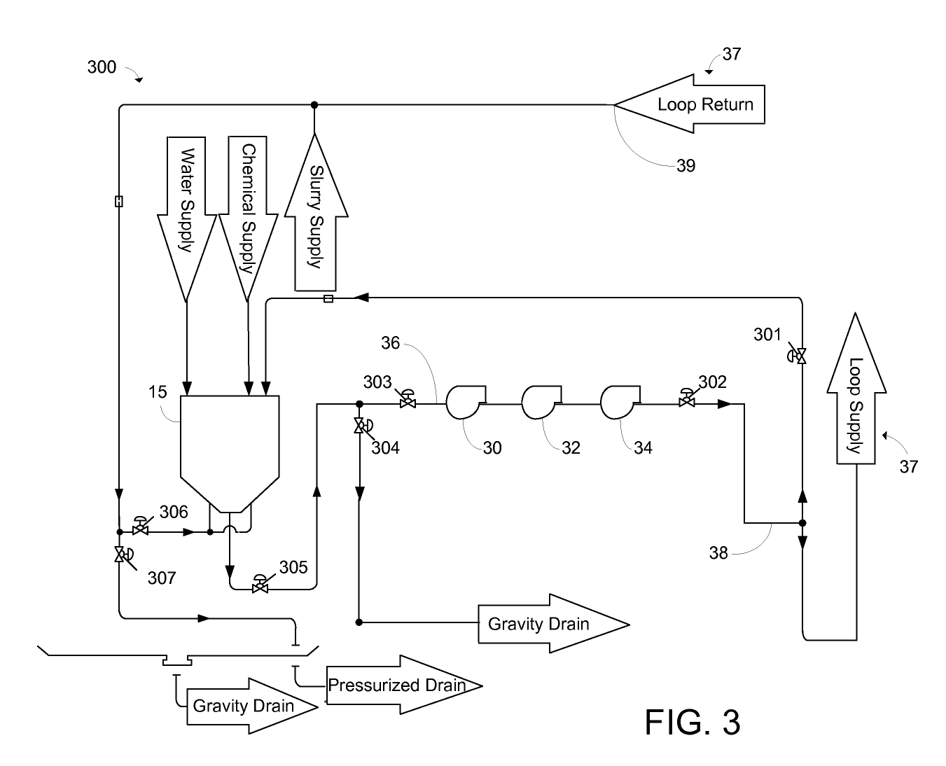

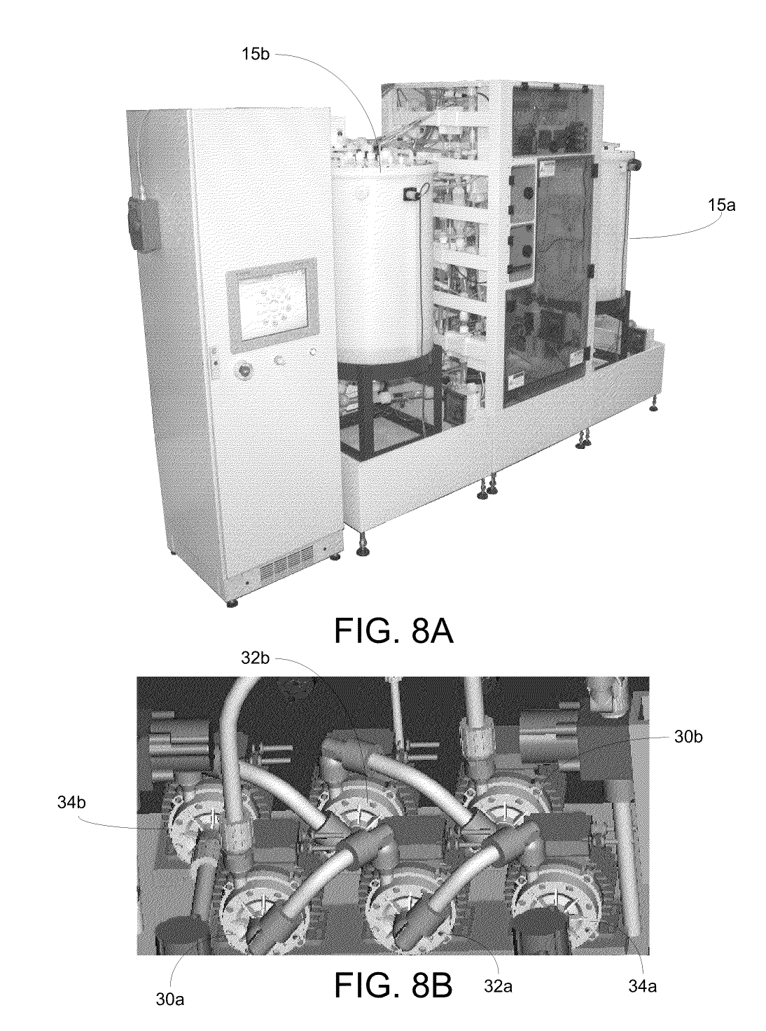

FIG. 3 shows a bulk delivery system 300 with a plurality of distribution pumps arranged in series according to a preferred embodiment of the present invention. The embodiment shown in FIG. 3 uses three pumps, although as described below in some embodiments a different number of pumps could be used. Process material is blended and then held in tank 15 and then distributed to the global process material loop 37 by pumps 30, 32, and 34. Bulk delivery system 300 shown in FIG. 3 would typically be one of two identical delivery sub-systems, each having a separate tank and pumping system. Such an arrangement is shown in FIGS. 8A-8B, where each sub-system comprises a blending/holding tank and a set of three pumps connected in series, but with both sub-systems delivering process materials to the same global loop. For example, the delivery system having pumps 30a, 32a and 34a would deliver process material from blending/holding tank 15a, where the delivery system having pumps 30b, 32b and 34b would deliver process material from blending/holding tank 15b.

As the process materials in the first or primary sub-system tank are distributed, the primary tank level will fall to a user defined set point value, and the secondary sub-system will begin supplying process materials to the global loop without interruption. The complete system (including both the primary and secondary sub-systems) preferably includes six total pumps along with the two separate tanks, with each separate bulk delivery sub-system having one set of three pumps arranged in series and each set providing delivery from a different tank holding a “batch” of process materials. In a preferred embodiment, both sub-systems are controlled by a single controller, although multiple controllers could be used.

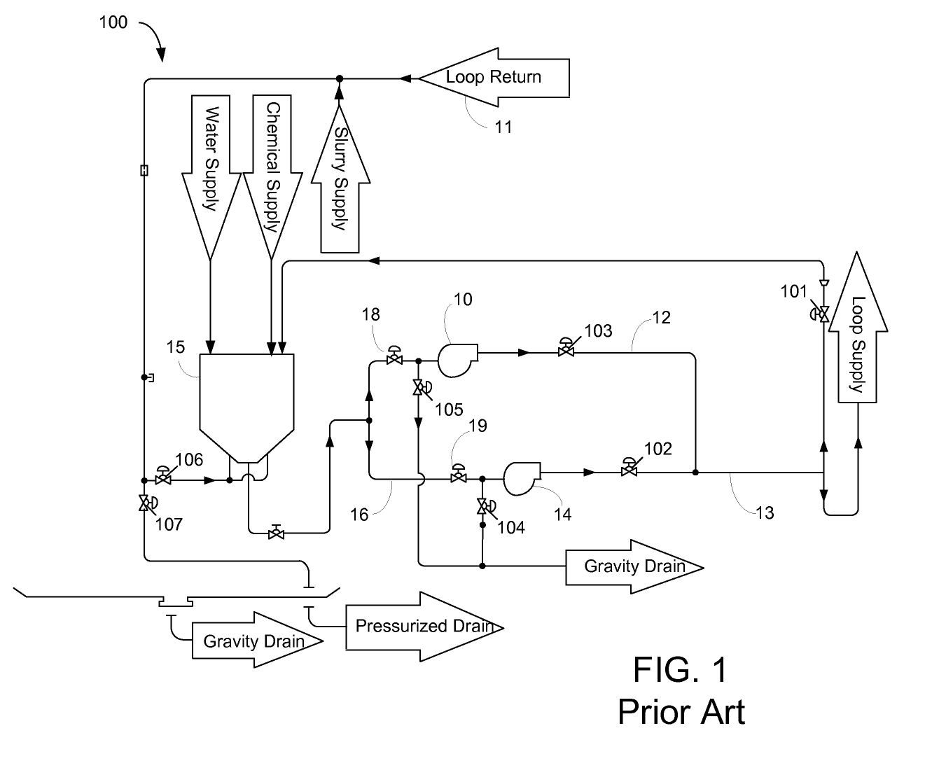

In the preferred embodiment of FIG. 3, three pumps are arranged in series along a single supply line as shown. First pump 30, second pump 32 and third pump 34 are all located in series, that is, one after another on the same main supply line 36. Similar to FIG. 1, pressure sensors for monitoring loop supply pressure and loop return pressure are located at points 38 and 39, respectively. Preferably, the size of pumps 32, 34, and 36 is chosen such that any two pumps will be able to maintain the desired supply pressure and flow rate (or “performance”) for a particular application. The pressure and flow output for each pump in an arrangement such as that of FIG. 3 is preferably about 54 psig @ 27 lpm. It is noteworthy that the preferred pumps of the embodiment of FIG. 3 are smaller that those of a typical prior art system as shown in FIG. 1.

While the embodiments described with respect to FIG. 3 include three pumps, the invention can be generalized to “n” pumps, with n greater than 1 and preferably n greater than 2. Moreover, while the embodiments described above include compensation for a single failed pump, systems could also compensate for multiple failed pumps. If the maximum pressure output “p” of each of the individual pumps adds in an approximately linear manner and the required maximum output of the system is P, the minimum number “m” of pumps operating to supply the required pressure P is P/p. In some preferred embodiments, the minimum number of pumps “m” will equal “n” (the total number of pumps) minus one. In other preferred embodiments, the difference between “m” and “n” could be two or more, as long as the minimum number of pumps can operate to supply the required pressure.

The pumps are preferably of a type, such as centrifugal pumps, whose output adds approximately linearly. Moreover, the pumps are preferably of a type such that the pressure drop across an inoperative pump does not impose such a burden on the remaining pumps to require an increased capacity to compensate for the pressure drop. In some embodiments, a bypass could be used around an inoperative pump. The pressure drop across the system when a pump fails may be somewhat greater than the P/n because there may be a small pressure drop across the inoperative pump.

Pumps 32, 34 and 36 are preferably smaller than the relatively larger pumps of a parallel arrangement such as that shown in FIG. 1. Because pump cost is typically directly proportional to pump capacity, smaller pumps are typically less expensive than larger ones. In other words, a small pump with half the capacity of a large pump will typically cost half as much as the larger pump. Since a preferred embodiment of the present invention includes three small pumps each with half the capacity of the primary and back-up pumps in a typical parallel arrangement, the cost associated with a serial arrangement of three pumps is reduced by approximately 25%.

One of ordinary skill in the art will appreciate that a particular application may not require 100% of the performance of the bulk delivery system, that is, 100% of the performance of the multiple pumps operating simultaneously in series. It should also be appreciated that a serial arrangement of more than three pumps is considered within the scope of this exemplary description. In such a case, the sizing of the pumps should be chosen such that less than all of the pumps, for example, operating together (simultaneously) are capable of providing sufficient pressure and flow for a given process application should a loss of any single pump be realized.

It is preferable that all pumps operate at the same speed, that is, frequency or rpm. To this end, if each smaller pump 32, 34 and 36 of FIG. 3 is 50% the size of a larger pump used in a parallel arrangement where only one pump provides full capacity at a time, then the three smaller pumps operating simultaneously are more than adequate to maintain a desired supply pressure and flow rate for a particular application. For example, at full speed the three smaller pumps can provide 150% capacity. Therefore, the three smaller pumps can together operate at slower speeds and continue to provide 100% capacity required for a given process application. Further, if one of the smaller pumps were to fail, the remaining two pumps, each having 50% the capacity of a relatively larger pump used in a parallel arrangement, could together be brought up to the appropriate speed to provide 100% supply pressure and flow rate. In other words, a failure of the first 32, second 34, or third pump 36 can be compensated for by the remaining two operational pumps.

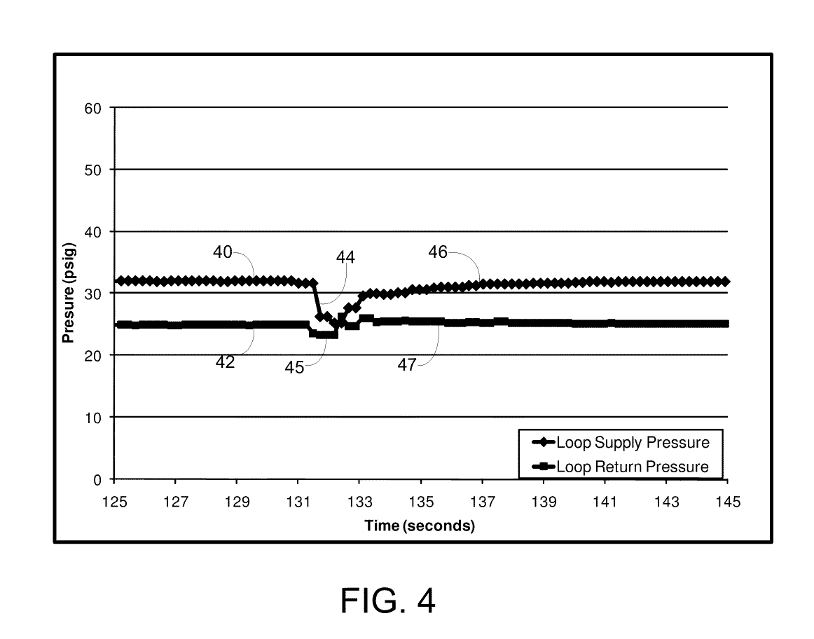

FIG. 4 theoretically illustrates a system pressure recovery by all but one of a multiple, series arrangement of pumps along a single supply line, such as would be realized by embodiments of the present invention should a single pump failure occur during material processing operation. Here, normal supply and return pressure are shown at points 40 and 42 respectively. During a pump failure, supply and return pressure drop, shown by points 44 and 45 respectively. In a preferred embodiment of the present invention, the pressure drop in the event of a pump failure will be less than 20 psig, more preferably less than 10 psig. The perturbations in pressure will also preferably be less than 30% of the original pressure, more preferably less than 25%. The pressure will also preferably be returned to the desired line pressure within 15 seconds, more preferably within 10 seconds, even more preferably within 5 seconds. In a three-pump serial arrangement of pumps as described in one preferred embodiment of the present invention, a loss of a single one of the three pumps would typically result in a loss in pressure of approximately 33%. As the system detects the pressure drop caused by the failing pump, as described below, the remaining pumps are signaled to increase speed until recovery of supply and return pressure is realized, as shown at points 46 and 47 respectively. (As described below, in some preferred embodiments the signal to increase speed will be sent to all of the pumps.) In other words, the system controls to pressure to ensure that the pressure at the point of use remains above a certain minimum value. For example, in some embodiments it may be desirable to keep the pressure at the point of use above a certain value so that the flow controllers (such as mass flow controllers) controlling the delivery of process materials can deliver over their full range.

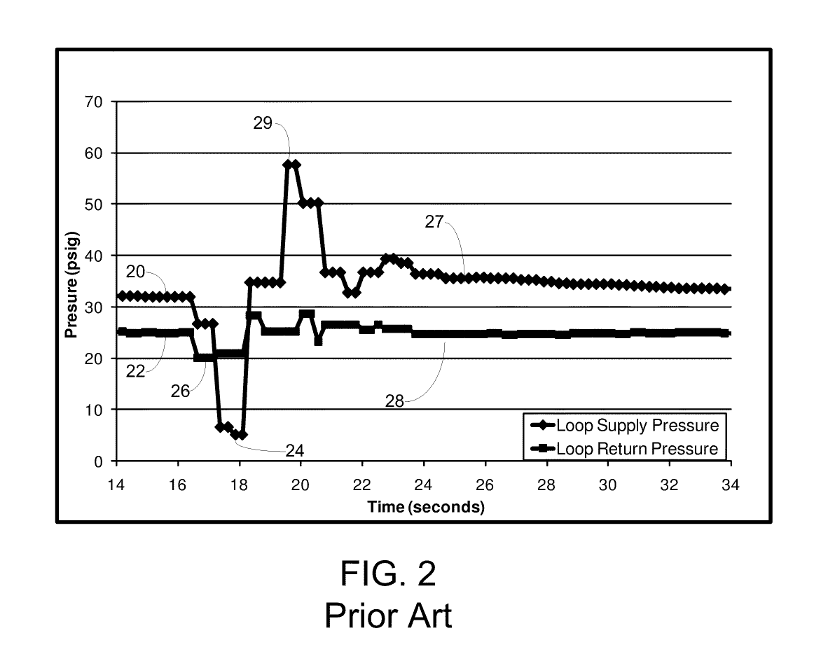

Note that the loss of pressures at 44 and 45 is significantly less than the loss of pressures indicated by 24 and 26 of FIG. 2, and without the significant pressure spike indicated by 29. Although a small pressure perturbation may be realized during a pump failure of a series arrangement of pumps as described in the preferred embodiments herein, the pressure perturbation is significantly less than that typically realized in a prior art arrangement such as that described with respect to FIGS. 1 and 2.

One of ordinary skill in the art will recognize that more time is required to increase the speed of a pump from 0% to 100% rather than from 50% to 100%. In the case of a pump failure, since the speed of the remaining two pumps is increased from a starting point of about 50% instead of 0%, the desired pressure and flow of the system can be more quickly restored. In other words, since all the pumps are already operational at the time of a pump failure, much less time is required for the remaining pumps to arrive at a desired performance level than would be required if those pumps were, for example, initially switched off.

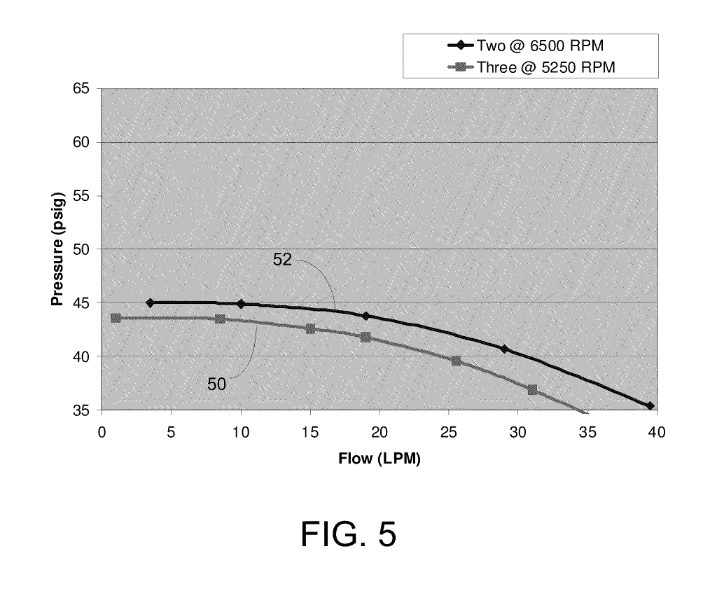

FIG. 5 graphically shows the performance of smaller pumps used in at least one preferred embodiment of the present invention, comparing the performance of three simultaneously operating pumps with the performance of two simultaneously operating pumps of the same capacity but at a different speed (RPM). FIG. 5 plots flow, in liters per minute (LPM) against pressure, in pound-force per square inch gauge (psig). FIG. 5 illustrates that in the case of a failure of one of the three normally simultaneously operating pumps operating at a particular speed, two pumps operating at another particular speed provides comparable performance. Here, line 50 represents the three pumps operating simultaneously at 5250 RPM, and line 52 represents the two pumps operating simultaneously at 6500 RPM. As shown in the figure, the two pumps 52 are actually outperforming the three pumps 50, more than adequately overcoming a loss of one of the three pumps as in the case of a pump failure.

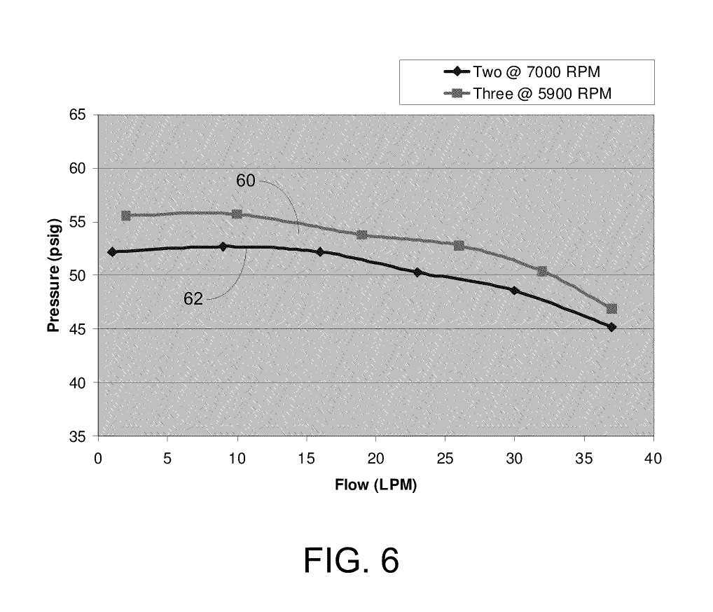

FIG. 6 compares the performance of a series arrangement of three pumps operating at a speed of 5900 RPM (line 60) with the performance of two pumps (representing a failure of one of the three pumps) operating simultaneously at a speed of 7000 RPM (line 62). In contrast to the results shown in FIG. 5, the two pumps 62 slightly underperform the three pumps 60, although the difference is only 1 or 2 psi. Significantly, the morphologies of the curves are very similar so the same control algorithm should be able to be used with each.

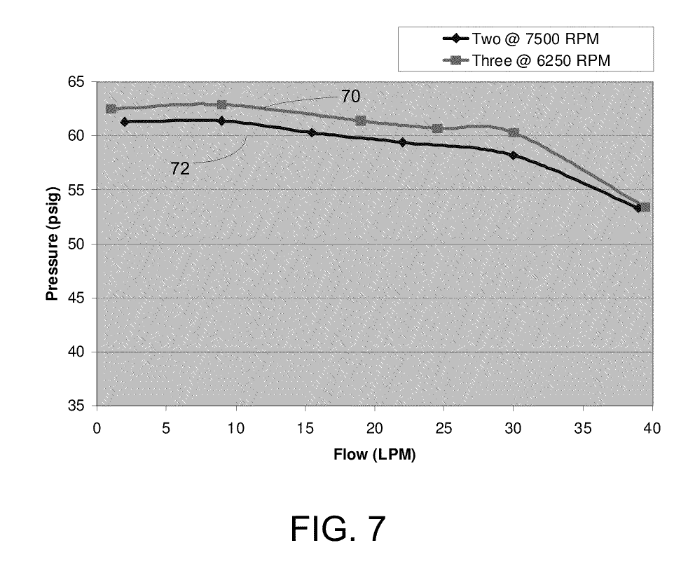

Similar results are shown in FIG. 7, where line 72 representing two pumps operating at 7500 RPM slightly underperforms the three pumps operating at 6250 represented by line 70. Although the two-pump outputs of FIGS. 6 and 7 (lines 62 and 72 respectively) are slightly below the three-pump outputs, while the two-pump output in FIG. 5 is above the three-pump output, in practice it would be preferable for the two outputs to be as close as possible. This performance could be achieved by slightly raising or lowering the speed of the two-functional pumps. As described in greater detail below, in practice the closed loop pressure control of a preferred embodiment would raise the rpm of the remaining pumps until the minimum set pressure and flow values are reached. A graph representing this preferable adjustment of the two-pump output of FIG. 5, for example, would show curves 50 and 52 largely superimposed upon each other.

While there are a number of advantages to the serial arrangement of pumps described above, there are some difficulties associated with such an arrangement. For example, the pumps typically used in bulk delivery systems such as the ones described above, are centrifugal pumps and not self-priming pumps. In the pump arrangement of the present invention, it may be difficult to prime the pumps when all of the pumps in series are started at the same time. A preferred approach to priming the pumps includes initially operating only the first pump in the series so that it is allowed to flood and pressurize the remaining two pumps. That is, the remaining two pumps remain in an “off” position as the first pump fills the remaining pumps with process material. After a certain period of time, the remaining two pumps may be ramped from a speed of zero RPM to the speed of the first pump.

Another difficulty associated with the arrangement of multiple pumps in series is that in the event of a pump malfunction it may be difficult to tell which pump has failed. In some preferred embodiments, the pressure and flow outputs of each individual pump may be measured and monitored. In this case, should a pump of the series arrangement fail during operation, the pump which has failed can be easily determined. However, it is typically not cost effective to monitor the pressure and flow output of each individual pump. Overall system cost can be reduced by monitoring only overall system pressure and flow rather than the outlet pressures of each pump.

Where the individual outlet pressures of each pump are not monitored, it may not be readily apparent which pump fails among the multiple pumps in the case of a pump failure. In this case, should a pump of the series arrangement fail during operation, the failure can be detected by a reduction in total system pressure or flow and a signal to increase speed can simultaneously delivered to all the pumps in the series to restore operational pressure and flow to a desired level. Obviously, the failed pump will typically not provide increased pressure or flow even though it receives the signal to increase speed, but the remaining pumps receiving the signal will respond favorably by increasing pressure and/or flow and operational levels will be restored.

According to preferred embodiments of the present invention, a feedback loop system is incorporated which provides continuous or periodic detection of at least system flow and pressure, and provides a signal to the pumps corresponding to a difference between the desired and actual pressure and flow measurements. Because in some cases the failed pump may continue to provide some level of performance before it is determined which pump has actually failed, the feedback loop provides for delivery of a signal that appropriately maintains the desired measurement of pressure and flow based on detected measurements of the combined pumps regardless of the output of the failed (or failing) pump. If the pump has a feature where it handles the closed loop control, a pressure or flow set point in combination with a pressure or flow signal and the pump controller could be provided that could in turn modulate the speed (RPM) of the pump. Although a separate signal may be delivered to each pump, for the consideration of system cost, it may be preferable that only one signal is sent to all pumps to reduce the cost associated with a number of signal delivery devices, for example. In other words, it is preferable to employ closed loop control within the system software to modulate pump speed.

Once a pump has malfunctioned and the speed of the remaining pumps adjusted to compensate, eventually it should be determined which pump has failed so that it may be replaced and/or repaired. As discussed above, a bulk delivery system according to the present invention will typically include both a primary and a secondary delivery sub-system, each having a separate tank and pumping system. When the primary “batch” of process materials in the first tank falls to a preset level, the system transitions to the secondary “batch” of process materials stored in the second tank. In the case of a pump failure in one of the bulk delivery systems, the transition to the other system can occur at any point after the process materials in the secondary tank have been blended or are available for distribution. For example, the transition could occur immediately after the pump failure or when the tank in the sub-system has fallen to the normal preset level.

During the period in which the bulk delivery system (either primary or secondary) is off-line, the pumps associated with that system can be checked to determine which pump has failed. In a preferred embodiment, the malfunctioning pump can be identified by activating the pumps and monitoring the overall pressure output. In a first approach, power to each pump will be interrupted in succession while overall output is monitored until the failed pump is identified. This information is preferably provided through a user interface to maintenance personnel, for example. Instead of interrupting power to each pump, a second approach to determining a failed pump includes sending a control signal to each pump in succession while overall output is monitored until the failed pump is identified. The control signals could include, for example, a signal to increase and/or decrease pump speed. This approach would require the ability to deliver individual control signals to each pump. In some preferred embodiments, the power consumption of each pump could also be monitored to provide an indication as to which pump has malfunctioned.

A preferred method or apparatus of the present invention has many novel aspects, and because the invention can be embodied in different methods or apparatuses for different purposes, not every aspect need be present in every embodiment. Moreover, many of the aspects of the described embodiments may be separately patentable.

Although embodiments of the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. An apparatus for delivering process materials in a bulk delivery system, comprising:
a plurality of pumps arranged in series along a material supply line, wherein the capacity of each pump is such that less than all of the pumps operating simultaneously can provide a desired level of system performance for a given application.

2. The apparatus of claim 1, wherein the plurality of pumps comprises three pumps.

3. The apparatus of claim 2 wherein the sum of the maximum capacities of the plurality of pumps provides at least 150% of the desired level of system performance for a given application.

4. The apparatus of claim 1, wherein the sum of the maximum capacities of less than all of the plurality of pumps provides at least 100% of the desired level of system performance for a given application.

5. The apparatus of claim 1, wherein the capacity of each pump is such that all but one of the pumps operating simultaneously provides a desired level of system performance for a given application.

6. The apparatus of claim 1, wherein at least one of the plurality of pumps has a maximum pressure and flow output of 54 psig @ 27 lpm.

7. The apparatus of claim 1 further comprising:
a pressure sensor for detecting the pressure in the material supply line; and
a controller for monitoring the pressure in the material supply line and, in the event that a pump failure causes the pressure to drop below a specified value, for sending a signal to all of the plurality of pumps to increase the speed of the pumps to raise the pressure to at least the specified value.

8. The apparatus of claim 7 further comprising:
a computer-readable memory storing computer instructions to perform the steps of:
monitoring pressure in the material supply line;
determining whether the pressure is below a specified value; and
if the pressure is below the specified value, delivering a signal to the plurality of pumps to increase pump speed.

9. A pumping system for delivering process liquids at a specified pressure, comprising multiple pumps arranged in series in a supply line, the pumps having the capability of providing the specified pressure with less than all of the pumps operating.

10. The pumping system of claim 9 in which each of the multiple pumps individually lacks the capability of supplying the process liquids at the specified pressure.

11. The pumping system of claim 9 in which the output of the system drops by less than one half the specified pressure when one of the multiple pumps fails.

12. A method for delivering process materials in a bulk delivery system, comprising:
providing a plurality of pumps arranged in series along a material supply line, wherein the capacity of each pump is such that simultaneous operation of all but one of the plurality of pumps provides a desired level of system performance for a given application.

13. The method of claim 12, further comprising:
monitoring pressure in the material supply line;
determining whether to increase or decrease pump speed based on the pressure in the material supply line;
delivering a signal to increase or decrease pump speed to at least one of the plurality of pumps based on the determination step.

14. The method of claim 13, in which delivering a signal includes delivering the signal to each pump.

15. The method of claim 14, in which delivering the signal to each pump includes simultaneously delivering the signal to each pump.

16. The method of claim 12 in which providing a plurality of pumps arranged in series comprises providing a plurality of pumps arranged in series, said pumps being primed for operation by:
operating a first pump in the series of the plurality of pumps to flood the remaining pumps, and increasing the speed of at least one of the remaining pumps from zero rpm to the speed of the first pump.

17. A method for identifying a failed pump in a system having a plurality of pumps arranged in series along a material supply line, wherein the capacity of each pump is such that less than all of the plurality of pumps operating simultaneously provide a desired level of system performance for a given application, comprising:
manipulating the performance of at least one of the plurality of pumps, and
monitoring system output until the failed pump is identified by a change is system output.

18. The method of claim 17, wherein manipulating the performance of at least one of the plurality of pumps includes successively interrupting power to each pump.

19. The method of claim 17, wherein manipulating the performance of at least one of the plurality pumps includes manipulating a control signal to each pump.

20. The method of claim 17, wherein the control signal includes a signal to increase or decrease pump speed.
